(19) United States
(12) Patent Application Publication
(10) Pub. No.: US 2006/0171569 A1
(43) Pub. Date: Aug. 3, 2006

(54) Video compression with blur compensation

(76) Inventor: Madhukar Budagavi, Dallas, TX (US)

Correspondence Address: TEXAS INSTRUMENTS INCORPORATED, P O BOX 655474, M/S 3999, DALLAS, TX, 75265, US

(21) Appl. No.: 11/327,904

(22) Filed: Jan. 9, 2006

Related U.S. Application Data
(60) Provisional application No. 60/642,573, filed on Jan. 10, 2005.

(51) Int. Cl. G06K 9/00; G06K 9/36

(52) U.S. Cl. 382/107; 382/236

(57) ABSTRACT

Video compression which utilizes information of blurring by including a blurred version of a prior frame as one of the reference frames for motion compensation.

### CROSS-REFERENCE TO RELATED APPLICATIONS

This application claims priority from provisional patent application No. 60/642,573, filed Jan. 10, 2005.

### BACKGROUND

The present invention relates to digital video signal processing, and more particularly to devices and methods for video compression.

Various applications for digital video communication and storage exist, and corresponding international standards have been and are continuing to be developed. Low bit rate communications, such as, video telephony and conferencing, led to the H.261 standard with bit rates as multiples of 64 kbps. Demand for even lower bit rates resulted in the H.263 standard.

H.264 is a recent video coding standard that makes use of several advanced video coding tools to provide better compression performance than existing video coding standards such as MPEG-2, MPEG-4, and H.263. At the core of the H.264 standard is the hybrid video coding technique of block motion compensation (BMC) and transform coding. BMC is used to remove temporal redundancy, whereas transform coding is used to remove spatial redundancy in the video sequence. Traditional block motion compensation schemes basically assume that objects in a scene undergo a displacement in the x- and y-directions. This simple assumption works out in a satisfactory fashion in most cases in practice, and thus BMC has become the most widely used technique for temporal redundancy removal in video coding standards.

The traditional BMC model, however, fails to capture temporal redundancy when objects in the scene under go affine motion such as zoom and rotation. There are several techniques in the literature which modify the motion compensation scheme to take care of affine motion. Another scenario where the traditional BMC model fails to capture temporal redundancy is when there is brightness variation in the scene or when there are scenes of fade in the video sequence. Fades (e.g. fade-to-black, fade-to-white, etc.) are sometimes used to transition between scenes in a video sequence. The H.264 standard introduces a new video coding tool called the weighted prediction to efficiently encode such scenes of fades.

One more scenario where the traditional BMC model fails to capture temporal redundancy is when there is blurring in the video sequence. Blurring typically occurs in video sequences when the relative motion between the camera and the scene being captured is faster than the camera exposure time. Blurring that occurs in such scenarios is called motion blurring. The occurrence of motion blur is quite frequent when video is captured using handheld video recorders such as camera phones and camcorders. FIG. 2a shows an example of motion blur that happens when a stationary object is filmed using a handheld camcorder. The motion in such scenes comes from human motion or naturally occurring hand tremors that propagate to the handheld camera. Motion blur is also sometimes artificially created in computer generated video sequences to provide a natural feel to the video sequence. This is evident in the “Spiderman-2” movie trailer around frame 2295 of the video clip, one can observe the motion blur on the buildings in the left of the images. Blurring is also used as a special effect to smoothly transition between scenes in a movie; this is evident in the “I, Robot” movie trailer around frame 1460 of the video clip. Blurring also occurs when objects at different depths in a scene are focused and defocused as is done in movies to focus on different actors in a scene.

However, traditional block-based motion compensation techniques such as those used in H.264 become ineffective when blurring starts to occur in the video sequence.

### SUMMARY

The present invention provides techniques that exploit the blurring information in video to provide improved compression performance in the presence of blur in video sequences by including blurred versions of reference frames for motion estimation.

### BRIEF DESCRIPTION OF THE DRAWINGS

FIGS. 1a-1c are a flowchart and functional block diagrams.

FIGS. 2a-2c show a video sequences with blurring and experimental results.

FIGS. 3a-3b illustrate motion compensation reference frames.

### DETAILED DESCRIPTION OF THE PREFERRED EMBODIMENTS

1. Overview

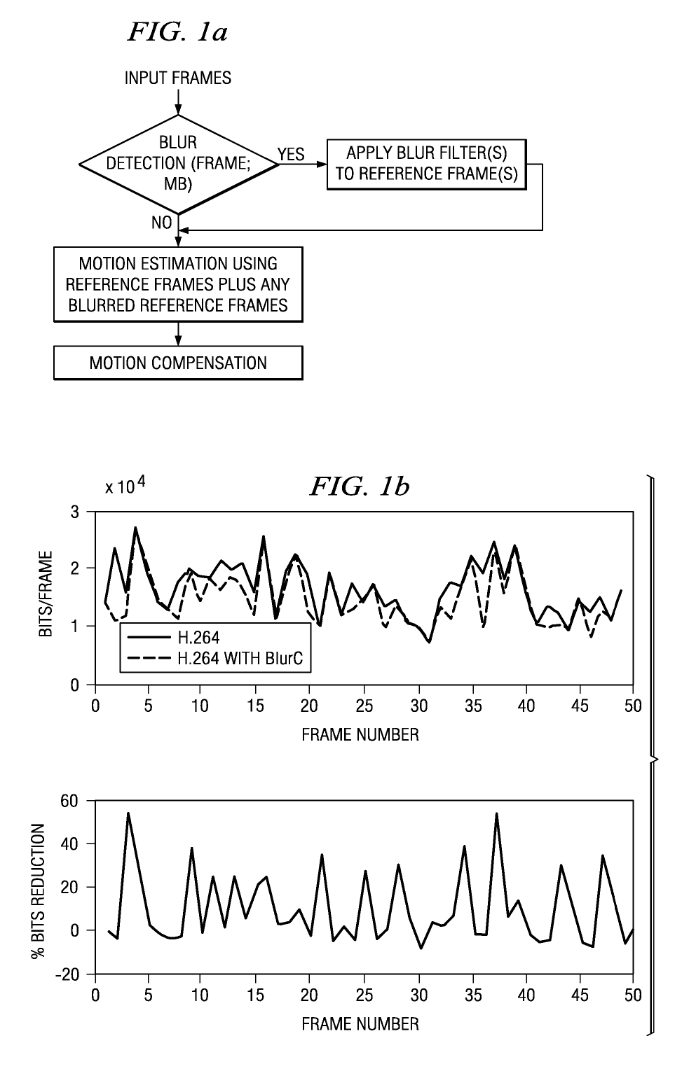

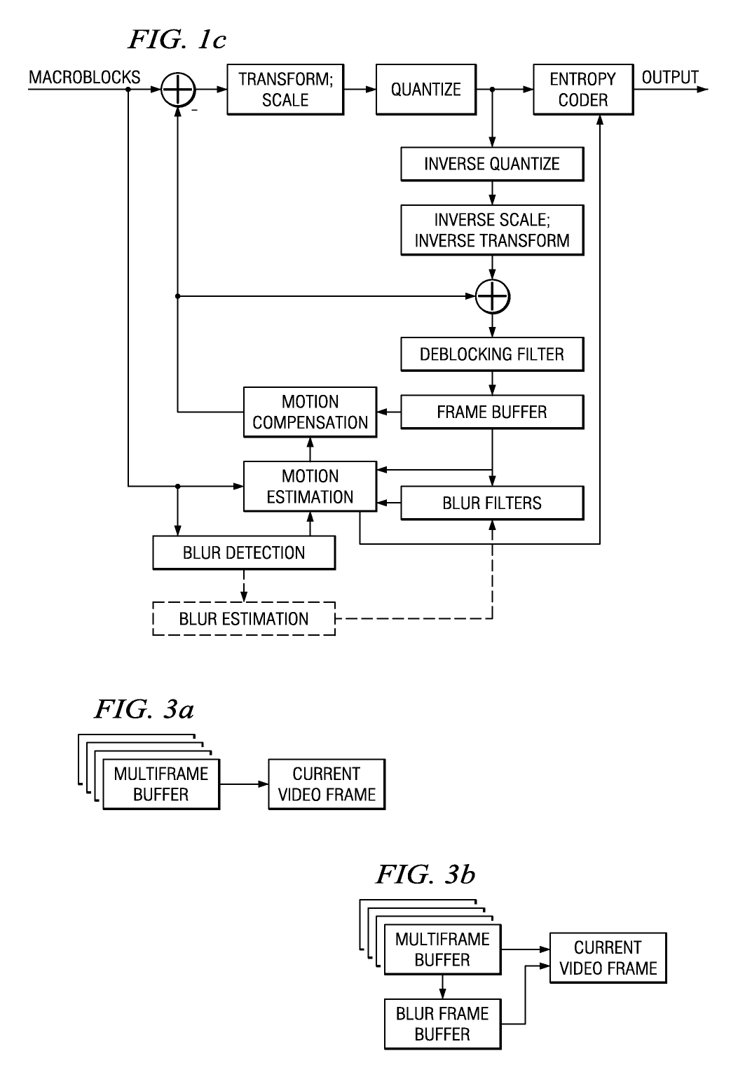

The preferred embodiment video compression methods include a blurred version of a prior frame together with the prior frame(s) as motion compensation reference frames. Thus frames containing portions with blurred versions of prior frames will have more accurate prediction from motion vectors and thereby require fewer texture encoding bits. An encoder transmits information as to which blur filter should be used, and a decoder applies the appropriate blur filter to the appropriate reconstructed frame(s) for predictions. FIG. 1a is a flowchart, and FIGS. 1b-1c illustrate an encoder and decoder which implements a preferred embodiment method.

Preferred embodiment systems such as video decoders and displays, cellphones, PDAs, notebook computers, etc., perform preferred embodiment methods with any of several types of hardware: digital signal processors (DSPs), general purpose programmable processors, application specific circuits, or systems on a chip (SoC) such as combinations of a DSP and a RISC processor together with various specialized programmable accelerators. A stored program in an onboard or external (flash EEP)ROM or FRAM could implement the signal processing. Analog-to-digital converters and digital-to-analog converters can provide coupling to the real world, modulators and demodulators (plus antennas for air interfaces) can provide coupling for transmission waveforms, and packetizers can provide formats for transmission over networks such as the Internet.

2. Video Compression with Blur Compensation on a Frame Level

The H.264 standard uses multiframe video coding in the sense that more than one prior frame can be the reference frame as shown in FIG. 3a. The macroblocks in the current frame of the video signal are predicted from multiple previous frames by using motion estimation compensation. (The multiframe buffer can consist of future frames if forward prediction is used.) The preferred embodiment video encoding schemes that supports blur compensation introduce an additional frame buffer called the blur frame buffer (BFB) as shown in FIG. 3b. This additional frame buffer consists of a blurred version of the previous frame. Thus the macroblock in the current video frame gets predicted from frames in the multiframe buffer and the BFB.

The blurring filter used to generate the frame in the BFB is signaled from the encoder to the decoder as side information, e.g., as part of the Supplemental Enhancement Information (SEI) in H.264. The decoder uses this information to generate the blurred frame in its BFB from its prior reconstructed frame.

The encoder iterates over a set of predefined blur filters to find the best blur filter in terms of rate reduction. Consider blur filters of two types:

1) averaging filter: b_{aK}(.,.) which averages over a block of size K×K

2) motion blur filter: bₘ_{_{—}}ᵣ_{_{—}}_{θ}(.,.) where r denotes motion magnitude and θ denotes direction of motion
Let ones(m,n) denote an m×n matrix will all entries being equal to 1. We considered the following set of seven simple predefined blur filters in the coder. The first three blur filters are averaging filters and the remaining blur filters are motion blur filters.

$${b}_{a 4} = \frac{1}{16} ones ( 4 , 4 )$$

$${b}_{a 8} = \frac{1}{64} ones ( 8 , 8 )$$

$${b}_{a 16} = \frac{1}{256} ones ( 16 , 16 )$$

$${b}_{m\_ 4 \_ 0} = \frac{1}{4} ones ( 1 , 4 )$$

$${b}_{m\_ 4 \_ 90} = \frac{1}{4} ones ( 4 , 1 )$$

$${b}_{m\_ 6 \_ 0} = \frac{1}{6} ones ( 1 , 6 )$$

$${b}_{m\_ 6 \_ 90} = \frac{1}{6} ones ( 6 , 1 )$$

The blur compensation technique is useful only in the region of blurs. The use of this video coding tool is similar to that of the weighted prediction tool of H.264 which is mainly useful only in the region of fades.

The complexity of the foregoing preferred embodiment brute force blur compensation encoder is high. Hence, to reduce computation complexity, preferred embodiment methods may run the blur compensation algorithm only in the regions where there is blurring. Detect such regions by using techniques of video camera auto-focusing. In the encoder iterate over a set of pre-defined blur filters to find the best blur filter in terms of rate reduction. Improve the compression performance and potentially reduce complexity by estimating the blur using transform domain processing.

3. Experimental Results for Frame Level Blur

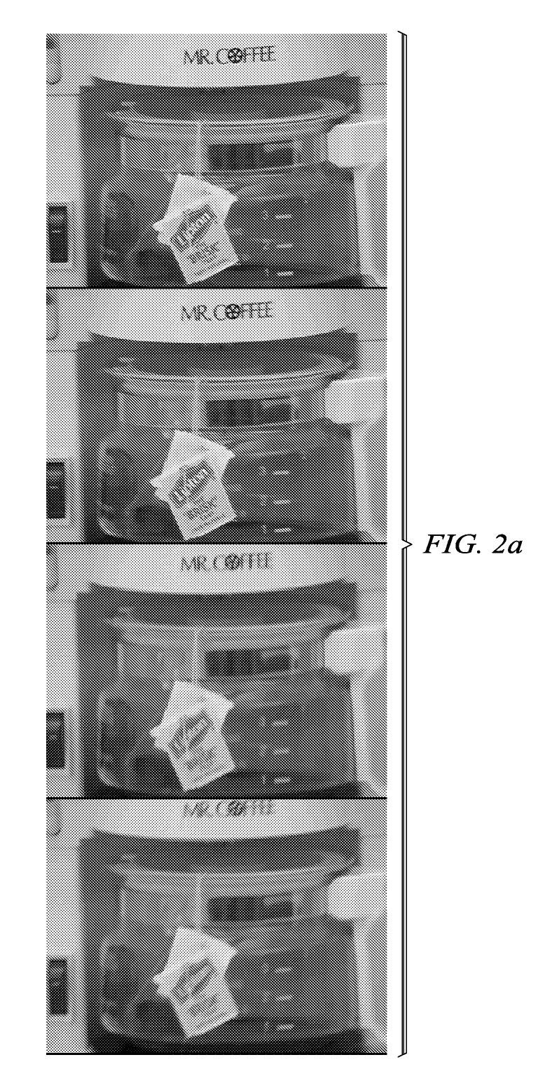

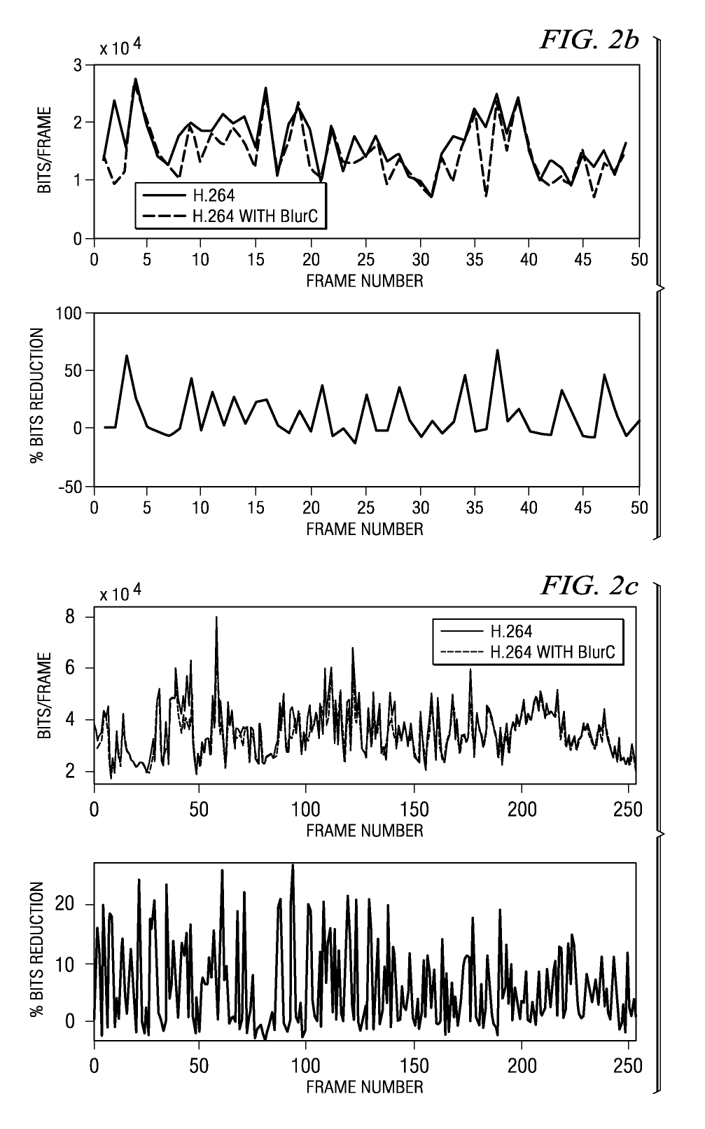

The extended H.264 video coder with blur compensation has run over 50 frames of the sequence shown in FIG. 2a, which is of QVGA resolution (320×240) at 30 fps. FIG. 2b shows the bitrate reduction over baseline H.264 that was achieved for the sequence. The maximum bitrate reduction per frame is 64%. The average bits reduction over the 50 frames is 11.96%. We used a quantization parameter value of 28 and 1 reference frame along with the blur frame buffer. We see similar results when the number of reference frames is increased to 5.

We also tested blur compensated H.264 video coder on blur episodes in the “I, Robot”, “Spiderman-2”, and “Oceans-Twelve” movie trailers. We used the same encoder settings that we used for the FIG. 2a sequence. The blur episode in the “I, Robot” trailer consists of a scene transition, and the ones in “Spiderman-2” and “Oceans-Twelve” trailers consist of motion blurs. The “I, Robot” frames are of resolution 480×256 and the “Spiderman-2” and “Oceans-Twelve” frames are of resolution 480×208. Tables I and 2 present the results for “I, Robot” and “Spiderman-2”. FIG. 2c shows the results for 255 frames of “Oceans-Twelve” trailer around frame 493. The maximum bitrate reduction per frame is 26.5%. The average bits reduction over the 255 frames is 6.97%.

TABLE 1
Results for “I, Robot” blurred scene transition.

| | | H.264 | |
|---|---|---|---|
| | | with | % |
| Frame | H.264 | BlurC | reduction |
| number | (bits) | (bits) | in bitrate |
| 1455 | 52360 | 52360 | n/a |
| 1456 | 17616 | 11264 | 36.06 |
| 1457 | 23680 | 12696 | 46.39 |
| 1458 | 13880 | 13896 | −0.11 |
| 1459 | 12160 | 12000 | 1.31 |

TABLE 2
Results for “Spiderman-2” motion blurred scene.

| | | H.264 | |
|---|---|---|---|
| | | with | % |
| Frame | H.264 | BlurC | reduction |
| number | (bits) | (bits) | in bitrate |
| 2293 | 109904 | 109904 | n/a |
| 2294 | 79656 | 69600 | 12.62 |
| 2295 | 67848 | 61336 | 9.60 |
| 2296 | 71288 | 64760 | 9.16 |
| 2297 | 61344 | 56888 | 7.26 |
| 2298 | 49544 | 46704 | 5.73 |
| 2299 | 43992 | 41368 | 5.96 |
| 2300 | 35632 | 34176 | 4.09 |

4. Video Compression Using Blur Compensation at the Block Level

Blur compensation can also be done at a block level by using additional modes in motion estimation/compensation. Current video encoders search over a set of several modes (INTRA, INTER, INTER+4MV, etc.) to find the best encoding option. Blur mode would be one such additional mode in this set of modes over which the encoder does a search. Blur compensation at a block level would reduce a computational complexity in a scenario where only a portion of the video frame has a blur. It would also be useful in a scenario where there are different objects undergoing blur in different directions, e.g., the camera could be moving to the left and the main object of interest could be moving to the right.

5. Encoder/Decoder Functional Blocks

To perform blur compensation the encoder two additional processing blocks need to be considered:

1) Blur detection block.

2) Blur filter estimation block.

FIG. 1b illustrate these blocks of an encoder.

A blur detection block detects when there is blurring in the video sequence. To reduce computation complexity, run the blur compensation method only in the regions where there is blurring. Detect such regions by using video camera auto-focusing techniques; for example, see K-S. Choi et al, New Autofocussing Technique Using Frequency Selective Weighted Median Filter for Video Cameras, 45 IEEE Trans. Cons. Elec. 820 (1999) and references there in. This blur detection block basically reduces the computation complexity by not using blurring when there is no blurring in the video sequence.

A blur filter estimation block determines the type of blur filter to use. In the encoder iterate over a set of pre-defined blur filters to find the best blur filter in terms of rate reduction. Improve the compression performance and potentially reduce complexity by estimating the blur between two frames by using transform domain processing.

A decoder receives encoded blur filter information and applies the appropriate blur filter to reconstructed frames to generate blur prediction; see FIG. 1c.

6. Modifications

The preferred embodiments can be modified in various ways while retaining the feature of inclusion of a blurred reference for motion estimation.

What is claimed is:

1. A method of motion vector estimation, comprising:
(a) providing an input block of pixels;
(b) providing at least one prior reference frame of pixels;
(c) estimating blurring at said input block;
(d) when said estimating blurring indicates blurring at said input block,
(i) providing a blurred version of said reference frame; and
(II) estimating a motion vector for said block using said reference frame plus said blurred version of said reference frame; and
(e) when said estimating blurring indicates no blurring at said input block,
(i) estimating a motion vector for said block using said reference frame.

2. The method of claim 1, wherein:
(a) when said estimating blurring of said input block indicates a first type of blurring, said blurred version of said reference frame is blurred with said first type of blurring.

3. The method of claim 1, wherein:
(a) said blurred version of said reference frame includes said reference frame blurred with a plurality of types of blurring to yield a plurality of blurred versions of said reference frame; and
(b) said estimating a motion vector uses said plurality of blurred versions of said reference frame.

4. A video encoder, comprising:
(a) a blur detector coupled to a video input;
(b) a motion estimator coupled to said video input and to said blur detector, said motion estimator operable to estimate motion vectors with respect to one or more reference frames;
(c) wherein when said blur detector detects blur in a frame, said motion estimator includes in said one or more reference frames at least one blur-filtered version of one of said reference frames.

5. A video decoder, comprising:
(a) a motion compensation block predictor;
(b) a memory for one or more reference frames, said memory coupled to said predictor; and
(c) a blur filter coupled to said memory and to said predictor, whereby said predictor can predict a block from either a reference frame in said memory or a blurred version of said reference frame.
